(19) United States
(12) Patent Application Publication
(10) Pub. No.: US 2019/0394113 A1
(43) Pub. Date: Dec. 26, 2019

(54) SYSTEMS AND METHODS TO AUTOMATICALLY EVALUATE BLOCKCHAIN-BASED SOLUTION PERFORMANCE

(71) Applicant: Blocktest Global, Grand Cayman (KY)

(72) Inventor: Keman Huang, Somerville, MA (US)

(73) Assignee: Blocktest Global, Grand Cayman (KY)

(21) Appl. No.: 16/451,751

(22) Filed: Jun. 25, 2019

Related U.S. Application Data
(60) Provisional application No. 62/689,713, filed on Jun. 25, 2018.

(51) Int. Cl. H04L 12/26; G06F 16/182; H04L 9/06; H04L 9/32

(52) U.S. Cl. CPC H04L 43/50; H04L 43/04; H04L 2209/38; H04L 9/0643; H04L 9/3247; G06F 16/1824

(57) ABSTRACT

Systems and methods for automatically evaluating blockchain-based solution performance, measuring blockchain solution performance, calculating blockchain solution performance metrics, presenting performance information to a user, and securely storing performance information, may utilize a test network of nodes to implement a test environment provisioned with a particular network size and particular resources.

### CROSS REFERENCE TO RELATED APPLICATIONS

This application claims priority to and the benefit of co-pending U.S. Provisional Application Ser. No. 62/689,713 filed Jun. 25, 2018 titled “SYSTEMS AND METHODS TO AUTOMATICALLY EVALUATE BLOCKCHAIN-BASED SOLUTION PERFORMANCE” the full disclosure of which is hereby incorporated herein by reference in its entirety for all purposes.

### TECHNICAL FIELD

The present disclosure generally relates to blockchain-based solution performance testing.

### BACKGROUND OF THE INVENTION

The ability to effectively evaluate the performance of blockchain-based solutions is urgently needed in the blockchain community.

In March of 2018, Hyperledger Caliper was introduced. Caliper is described as “a blockchain performance benchmark framework, which allows users to test different blockchain solutions with predefined use cases, and get a set of performance test results.” Github.com/hyperledger/caliper (visited Jun. 7, 2018)

Earlier in 2017, researchers at the National University of Singapore, along with others, developed a blockchain performance framework called BLOCKBENCH and published an article entitled, “BLOCKBENCH: A Framework for Analyzing Private Blockchains.”

A blockchain is a data structure where information is stored in blocks that are chained together by reference to one or more other blocks, frequently using a cryptographic hashing algorithm to calculate a hash of one or more blocks to be used as the reference. Blockchain technology may be paired with a consensus mechanism, several of which are well known, like proof-of-work, proof-of-stake, or a designated authority that approves and/or signs new blocks, or the like, that allows multiple computers to reach a consensus about the data that will be stored in each new block. In this way, a blockchain consensus system apportions trust among the members of a networked blockchain system.

### SUMMARY

In accordance with an embodiment of the invention, a method for testing performance of a blockchain-based solution is provided, including receiving the blockchain-based solution; determining at least one requirement of a test network for operating the blockchain-based solution, wherein the test network comprises a plurality of nodes, and wherein the at least one requirement comprises the number of nodes in the test network and at least one role for each node; transmitting the blockchain-based solution and the requirement to the test network, wherein the test network is adapted to implement the requirements, operate the blockchain-based solution, and determine an information relating to the performance of the blockchain-based solution; and receiving from the test network the information relating to the performance of the blockchain-based solution. In some embodiments, this method also includes creating a record of the information relating to the performance of the blockchain-based solution, and storing the record on a blockchain. In further embodiments, this method includes creating the record by cryptographically signing the information, encrypting the information, or cryptographically hashing the information.

In accordance with another embodiment of the invention, a system for testing performance of a blockchain-based solution is provided, including a test network for operating the blockchain-based solution, wherein the test network comprises a plurality of nodes; and a gateway server, wherein the gateway server is adapted to receive the blockchain-based solution, determine at least one requirement of the test network for operating the blockchain-based solution, wherein the at least one requirement comprises the number of nodes in the network and at least one role for each node, transmit the blockchain-based solution and the requirement to the test network, and receive from the test network information relating to the performance of the blockchain-based solution. In some embodiments, the gateway server is adapted to create a record of the information relating to the performance of the blockchain-based solution, and store the record on a blockchain. In further embodiments, this gateway server is adapted to create the record by cryptographically signing the information, encrypting the information, or cryptographically hashing the information.

According to a further embodiment of the present invention, a method is provide for testing the performance of a blockchain-based solution, including the steps of: receiving the blockchain-based solution; determining at least one testing requirement of a test network for testing the performance of the blockchain-based solution, wherein the test network comprises a plurality of nodes, and wherein the at least one testing requirement comprises a number of nodes in the test network to be used for the testing and at least one testing role for each node; transmitting the blockchain-based solution and the at least one testing requirement to the test network; implementing the at least one testing requirement in said number of nodes in the test network; testing the blockchain-based solution with that number of nodes in the test network; determining a performance information relating to the blockchain-based solution; and receiving from the test network the performance information.

According to a still further embodiment of the present invention, a system for testing the performance of a blockchain-based solution includes a test network, having a plurality of nodes, configurable to test the blockchain-based solution; and a server, in communication with the test network, configured to: receive the blockchain-based solution; determine at least one testing requirement of the test network for testing the blockchain-based solution, wherein the at least one testing requirement includes how many nodes in the test network are to be used for the testing and at least one testing role for each node; transmit the blockchain-based solution and the at least one testing requirement to the test network; and receive from the test network performance information relating to the blockchain-based solution.

### BRIEF DESCRIPTION OF THE FIGURES

FIG. 1 provides a block diagram of a system architecture for a blockchain-based solution evaluation system according to an exemplary embodiment of the present invention.

FIGS. 2A and 2B are, together, a flowchart according to an exemplary embodiment of the present invention.

FIG. 3 is a flowchart of the method according to an exemplary embodiment of the present invention.

FIG. 4 is a flowchart of a process to check whether a submitted blockchain-based solution meets the requirements for evaluation according to an exemplary embodiment of the present invention.

FIG. 5 is a flowchart of a process to generate a testing environment package according to an exemplary embodiment of the present invention.

FIG. 6 is a flowchart of a blockchain node environment initialization process according to an exemplary embodiment of the present invention.

FIG. 7A is a flowchart of an evaluation task generation process according to an exemplary embodiment of the present invention.

FIG. 7B is a diagram illustrating a test network configuration according to an exemplary embodiment of the present invention.

FIG. 8 is a flowchart of an evaluation task execution process according to an exemplary embodiment of the present invention.

FIG. 9 is a flowchart of a performance data collection process according to an exemplary embodiment of the present invention.

FIG. 10 provides a block diagram of a system deployment architecture for a blockchain-based solution evaluation system according to an exemplary embodiment of the present invention.

### DETAILED DESCRIPTION

Inventive systems and methods for automatically evaluating the performance of blockchain-based solutions are described below.

As blockchain technology continues to evolve, blockchain-based solutions comprise a spectrum of software and computer code technologies. Typically, blockchain-based solutions include computer software (e.g., computer source code, object code, firmware, application, smart contract, subroutine, application programming interface (API), script, user interface, computer interface, technology interface, virtual machines, or the like) that create a blockchain, interact with a blockchain, or operate in a blockchain environment. For example, Ethereum client software and Ethereum node software are blockchain-based solutions that implement the Ethereum blockchain system. As another example, software that interacts with a blockchain, like a user interface or distributed application, is also a blockchain-based solution. Similarly, applications that are stored on a blockchain and define or change the blockchain system's behavior or rules are also blockchain-based solutions. Examples of the latter may include software that runs on the Ethereum Virtual Machine. On simpler systems, blockchain-based solutions may include a set of configurable access rules like the multisignature system on the Bitcoin blockchain. However, blockchain-based solutions are not limited to the examples described above and continue to be developed and refined. Methods and systems to evaluate the performance of such blockchain-based solutions are needed.

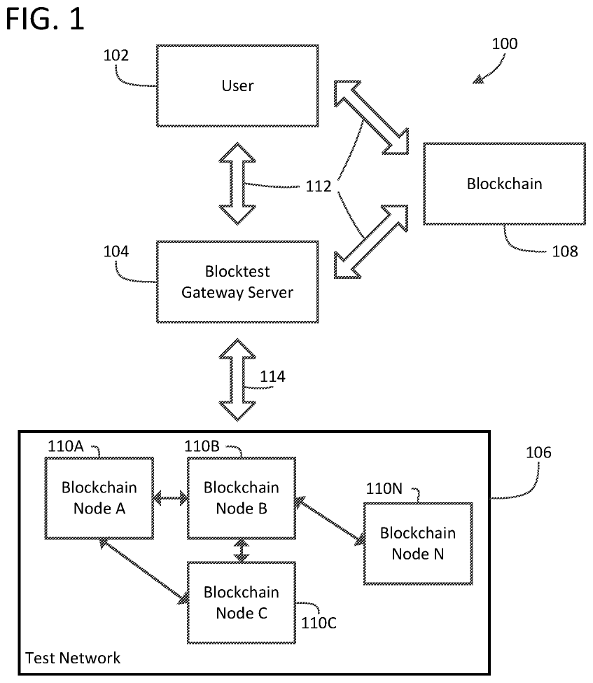

FIG. 1 provides a system architecture for a blockchain-based solution evaluation system according to an exemplary embodiment of the present invention. Preferably the system 100 includes blockchain 108, a blocktest gateway server 104, and a test network 106 comprised of a plurality of blockchain nodes 110. Though four blockchain nodes 110 are illustrated in FIG. 1, the test network 106 can comprise any number of blockchain nodes 110. Preferably each blockchain node 110 comprises computers with CPUs, RAM memory storage, and input/output (I/O) hardware, such as that provided by cloud computing services like Amazon Web Services (AWS). The blocktest gateway server 104 also preferably comprises one or more computers with CPUs, RAM memory storage, and input/output (I/O) hardware, such as that provided by cloud computing services like AWS. Through the use of virtualization, one physical computer server can function as more than one component in this system. The blockchain 108 is a blockchain system used to store data. It is also possible that blockchain nodes 110 may be dynamically created and destroyed through the use of virtualization, provisioned and unprovisioned as needed, and/or allocated and unallocated as needed, when the system is in use or at any other time.

The system 100 is preferably operated by a user 102, which may be a human operating a conventional terminal or user interface, such as a server computer, personal computer, laptop computer, tablet computer, mobile computer or the like. For example, the user 102 is a blockchain-based solution developer, or someone who is tasked with evaluating the performance of the provided blockchain-based solution. Alternatively, the user 102 may be another automated system that is integrated with the system 100 via an API or by performing the tasks that a human user would perform.

The blockchain 108, blocktest gateway server 104, and user 102's terminal or API are connected together via network 112, which may be a local network, wide area network, the Internet, or other computer network. At least the blocktest gateway server 104 is connected to the test network 106 via network 114, which may be a local network, wide area network, the Internet, other computer network, or the same network 112 used to connect the other elements of the system. The blockchain nodes 110 of test network 106 are also connected together by a network that may be a local area network, wide area network, the Internet, or the same network 112 or 114 used to connect the other elements of this system.

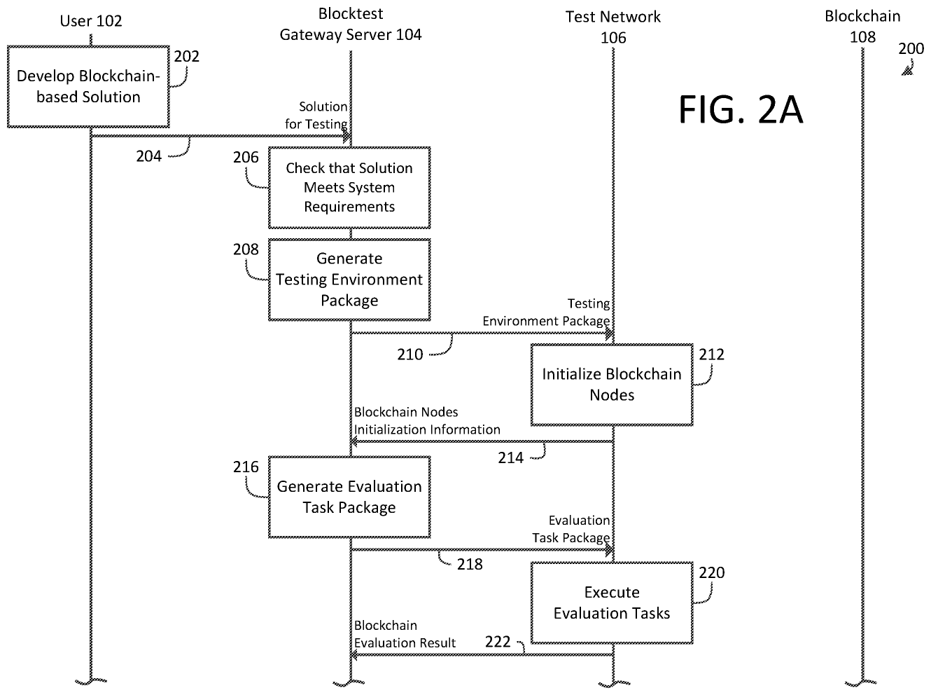

As will be described in more detail with respect to FIG. 2, in a preferred embodiment the user 102 uploads a blockchain-based solution to the blocktest gateway server 104 for evaluation via network 112, the blocktest gateway server 104 submits the solution to the test network 106 via network 114 to execute and evaluate the solution, receives the results via network 114, and transmits the results of the evaluation back to the user 102 via network 112. As discussed earlier, networks 112 and 114 can be different networks, the same network, segregated network segments (e.g., VLANs), or any other computer link. The user 102 or the blocktest gateway server 104 can transmit a request to the blockchain 108 to store the evaluation results, or can receive and verify past evaluation results that are stored in blockchain 108. In an alternate embodiment, not shown, the blockchain-based solution can be uploaded by an automated system acting as user 102, such as a continuous integration system or source-code repository software like Git, via an API instead of a human user.

FIG. 2 is a flowchart according to an exemplary embodiment of the present invention. FIG. 2A describes steps 202-222, and FIG. 2B describes steps 224-238.

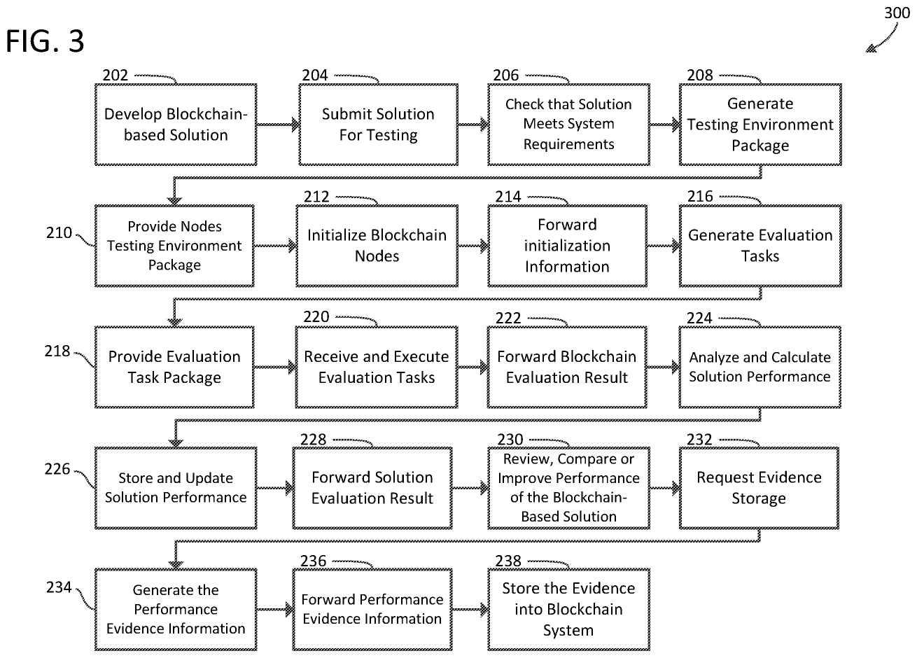

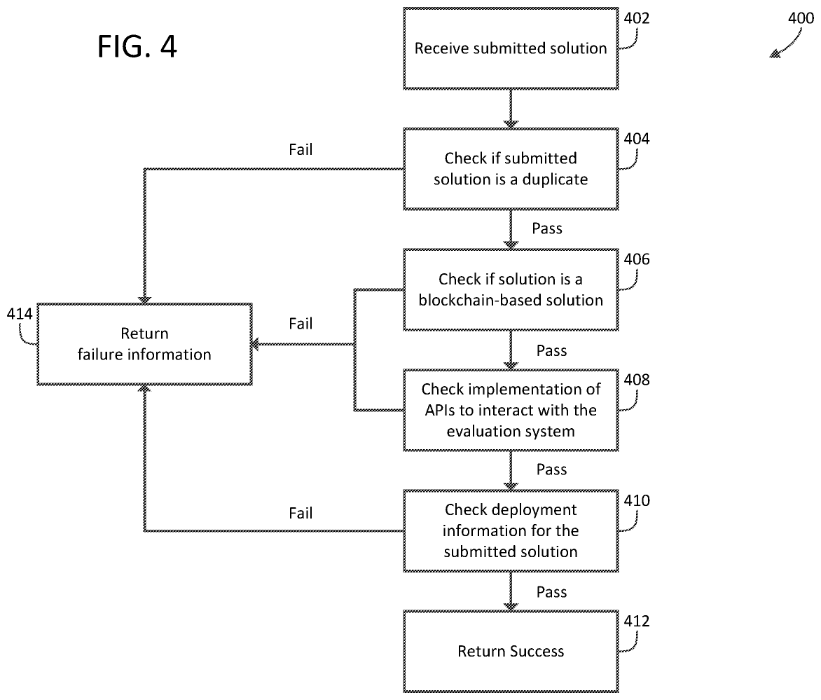

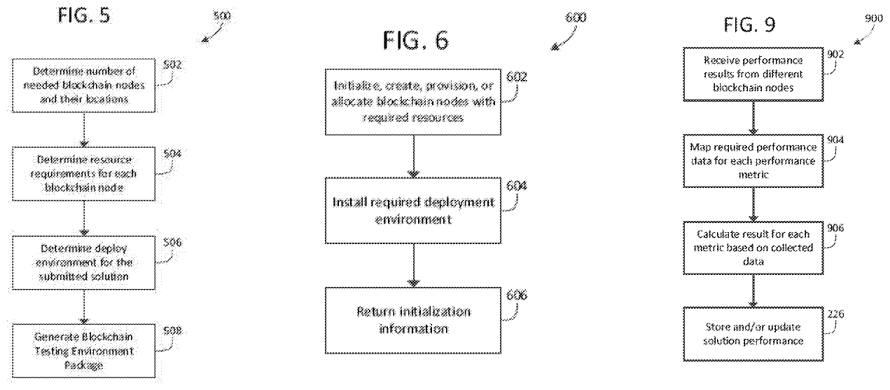

In step 202, in FIG. 2A, the user 102 develops a blockchain-based solution. If the user 102 is an automated system, then the automated system would either generate or receive a blockchain-based solution. In step 204, the blockchain-based solution is uploaded to the blocktest gateway server 104 for testing. In step 206, the blocktest gateway server 104 checks that the solution meets the requirements for evaluation by the system, as described in FIG. 4, checking, among other things, whether the submitted solution implements the required APIs correctly. In step 208, the blocktest gateway server 104 generates a testing environment package based on the uploaded solution as described in FIG. 5, containing, for example, the number of the blockchain nodes and the resource requirements for each node, like CPU, RAM, and I/O capabilities. In step 210, this testing environment package is uploaded to the test network 106. In step 212, the test network 106 initializes, creates, provisions, and/or allocates the blockchain nodes 110 using the testing environment package, as described in FIG. 6.

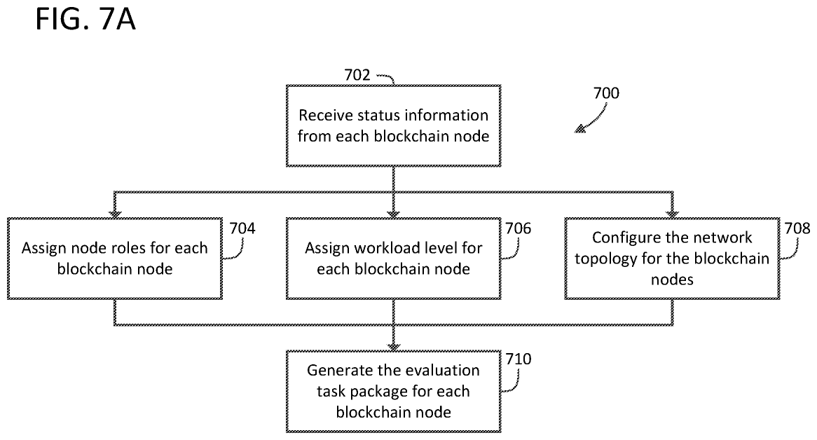

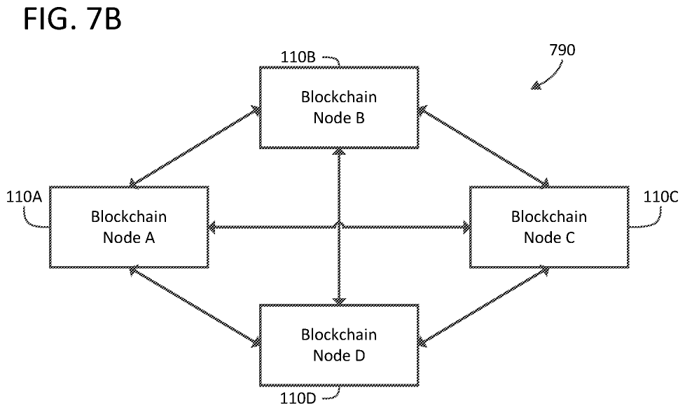

In step 214, after the blockchain nodes 110 of the test network 106 are initialized, the test network 106 transmits initialization information to the blocktest gateway server 104. In step 216, the blocktest gateway server 104 generates an evaluation task package as described in FIG. 7, including, for example, evaluation tasks and their schedules for each blockchain node, the connection status among different nodes, and the submitted solution. In step 218, this evaluation task package is transmitted to the test network 106. In step 220, the test network 106 using the blockchain nodes 110 execute the evaluation tasks based on the evaluation task package, as described in FIG. 8. During this execution, the test network 106 and the blockchain nodes 110 collect performance related raw data, which may be of a predefined type, such as transaction latency, throughput, and CPU and RAM consumption, as part of the evaluation results. In step 222, the evaluation results are transmitted to the blocktest gateway server 104.

Methods and systems for blockchain testing are described in application No. 62/681,941 which is hereby incorporated by reference in its entirety.

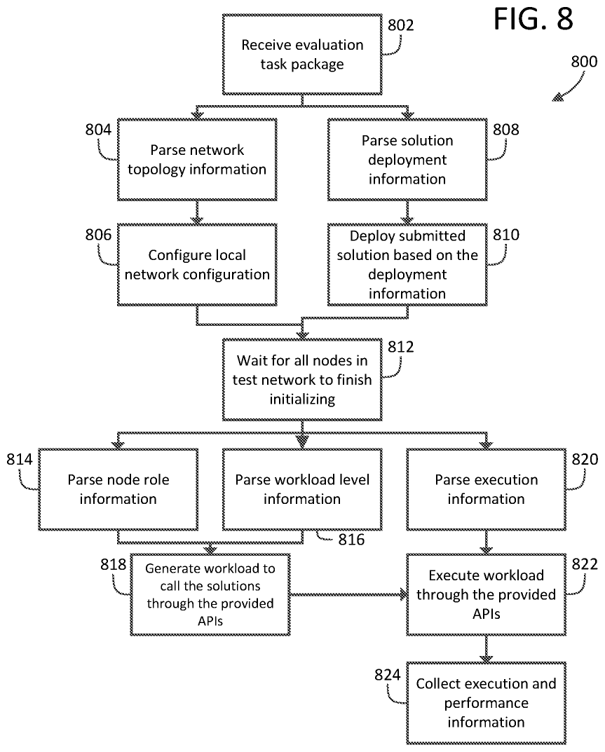

Turning to FIG. 2B, in step 224 the blocktest gateway server 104 analyzes the evaluation results and calculates performance metrics to measure the solution performance, as described in FIG. 9. In step 226, the blocktest gateway server 104 stores the solution performance data. In step 228, the blocktest gateway server 228 transmits the solution evaluation result to user 102. In step 230, user 102 can review those results, compare the performance of the solution with other solutions, or determine the direction to improve some specific performance for their solution. If the user has made modifications or otherwise wants to re-run the evaluation process, user can resubmit the blockchain-based solution by returning to step 204. If user 102 is an automated system, then the automated system may store these results somewhere that a human can access them, like in a source-code repository or make them accessible via a website.

In step 232, the user 102 optionally requests that the performance evidence be stored on the blockchain 108 by transmitting an evidence storage request to the blocktest gateway server 104. In step 234, the blocktest gateway server 104 generates performance evidence information, by encrypting the results, generating a hash of the results using a cryptographic hashing algorithm, generating an electronic signature of the results, or some combination of these steps. In step 236, this performance evidence information is transmitted to blockchain 108, and in step 238 the performance evidence information is stored in blockchain 108 for further use. Future users can use this performance evidence information stored in blockchain 108 to verify that blocktest server 104, test network 106, and blockchain nodes 110 performed the tests described herein and obtained the stated results, without having to go perform the tests independently.

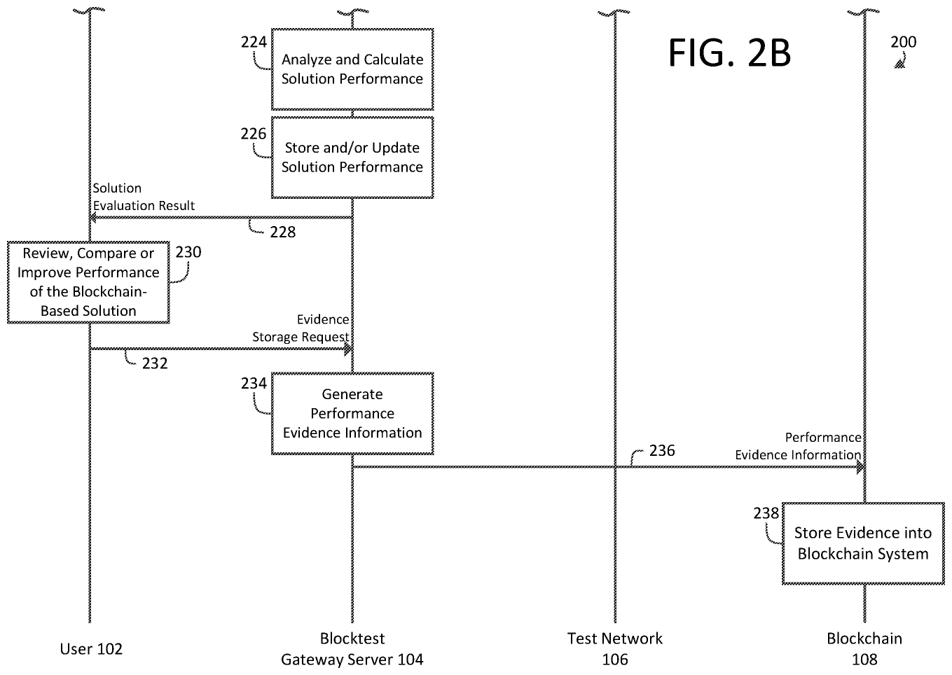

FIG. 3 is a flowchart according to an exemplary embodiment of the present invention. FIG. 3 describes the same steps as FIG. 2 in sequence, but with more flexibility regarding the performance of each step.

FIG. 4 is a flowchart of a solution checking initialization process 206 according to an exemplary embodiment of the present invention. In step 402, the blocktest gateway server 104 receives the submitted blockchain solution. In step 404, the blocktest gateway server 104 checks if the submitted solution is a duplicate of a solution that has been previously submitted. If the submitted solution is a duplicate, blocktest gateway server 104 returns failure information in step 414. If not, blocktest gateway server 104 proceeds to step 406, and checks if the solution is a blockchain-based solution. If the submitted solution is not based on blockchain technology, blocktest gateway server 104 returns failure information at step 414. Otherwise, blocktest gateway server 104 performs step 408, and checks the implementation of the APIs in the solution to make sure that they meet the requirements for evaluation by the system 100, and that the system will be able to use these APIs to interact with the solution during testing. If the APIs are not suitably implemented, blocktest gateway server 104 returns failure information at step 414. If the APIs are correct, blocktest gateway server 104 performs step 410, and checks the deployment information that is part of the solution so that the solution can be successfully deployed in the test network. If there is a problem with the deployment information, blocktest gateway server 104 returns failure information at step 414. If there is not a problem, blocktest gateway server 104 returns success, and the process of FIG. 2 continues with step 208, the generation of the testing environment package.

FIG. 5 is a flowchart of a process 208 to generate a testing environment package according to an exemplary embodiment of the present invention. In step 502, the blocktest gateway server 104 determines the number of needed blockchain nodes as well as their locations, which can be predefined by the user, predefined by the system, or dynamically determined by the system. In step 504, the blocktest gateway server 104 determines the resource requirements for each of the needed blockchain nodes, including, for example, the CPU, RAM, and I/O requirements. In step 506, the blocktest gateway server 104 determines the deploy environment for the submitted solution, which may include information about what software will need to be installed on the blockchain nodes 110 to execute the blockchain-based solution. In step 508, the blocktest gateway server 104 generates the blockchain testing environment package, including, for example, the number of blockchain nodes, their locations, the resource requirements, and their deploy environments. In the process of FIG. 2, this testing environment package is transmitted to the test network 106 with step 210.

FIG. 6 is a flowchart of a blockchain node environment initialization process 212 according to an exemplary embodiment of the present invention. After receiving the test environment package, the blocktest gateway server 104, in step 602, initializes, creates, provisions, and/or allocates the required blockchain nodes 110 with the required resources based on the test environment package. In step 604, each blockchain node 110 installs the required deploy environment from the test environment package. Once all the needed environments are installed and ready for use, the blockchain node 110 generates the initialization information indicating, for example, that the node is in a stand-by state, and other basic information about the node such as its IP address. In the process of FIG. 2, this initialization information is transmitted to the blocktest gateway server 104 in step 214.

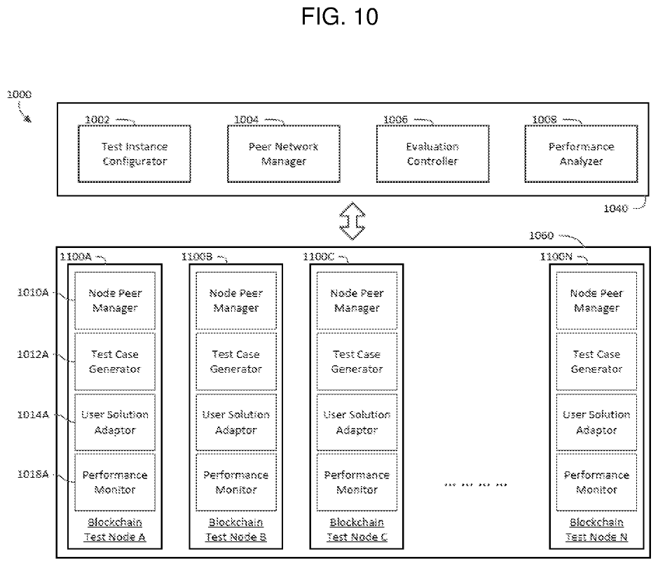

FIG. 7A is a flowchart of an evaluation task generation process 216 according to an exemplary embodiment of the present invention. In step 702, the test instance configurator 1002 (see, e.g., FIG. 10) receives basic information about the blockchain nodes 110, such information including, for example, their IP addresses and that they are ready for use. In step 704, the test instance configurator 1002 assigns roles for each blockchain node 110. The node roles may be defined by the user 102 in their submitted solution. For example, for a solution based on the Ethereum blockchain, there may be two different roles (or more): e.g., miners to generate blocks, and clients to generate transactions. The blockchain nodes 110 may be initialized with different commands depending on their roles. In step 706, the test instance configurator 1002 assigns a workload level, the number of transactions committed to the submitted solution in a given time duration, or different workloads to each blockchain node 110. In step 708, the network manager 1004 determines the network topology among the blockchain nodes 110—how they are to be connected together. FIG. 7B shows the topology of one possible network 790, an exemplary embodiment of test network 110, with four blockchain nodes 110 in a fully connected graph. Other network topologies are possible, such as networks with bottlenecks, or distinct sub-networks that are loosely connected. Finally, in step 710, the evaluation controller 1006 generates the evaluation task package, including the submission, the network topology configuration, the node role and workload level configuration for each blockchain node. In the process of FIG. 2, the blocktest gateway server 104 transmits this packet to the test network 106 in step 218.

FIG. 8 is a flowchart of an evaluation task execution process 220 according to an exemplary embodiment of the present invention. In step 802, the test network 106 receives the evaluation task package from the blocktest gateway server. In steps 804 and 806, the node peer manager 1010 (see, e.g., FIG. 10) of each blockchain node 110 parses the network topology from the evaluation package and configures the local network based on that configuration. In steps 808 and 810, node peer manager 1010 of each blockchain node 110 parses the solution deployment information from the evaluation package and deploys the solution to the blockchain node 110. In step 812, each blockchain node 110 then preferably waits until every blockchain node 110 is finished and the configuration has thus been deployed to the entire test network 106.

Once the test network 106 is fully deployed, the test case generator 1012 (see, e.g., FIG. 10) of each blockchain node 110 parses the node role information in step 814 and the workload level information in step 816. In step 818, the test case generator 1012 generates the test cases and workload to call the solutions through the APIs implemented for the system to access. In steps 820 and 822, the user solution adaptor 1014 (see, e.g., FIG. 10) parses the execution information and then interacts with the submission through the predefined APIs to execute the execution command based on the node role information and the workload information—for example, executing functions at the determined workload frequency. In step 824, the performance monitor 1018 (see, e.g., FIG. 10) of each blockchain node 110 collects the execution performance result for the submission, such as that which may be predefined by the user and the evaluation system. In the process of FIG. 2, each blockchain node 110 of the test network 106 then transmits the evaluation result back to the blocktest gateway server 104 in step 222.

FIG. 9 is a flowchart of a performance data collection process 224 according to an exemplary embodiment of the present invention. In step 902, the performance analyzer 1008 (see, e.g., FIG. 10) of the blocktest gateway server 104 collects the performance results from the blockchain nodes 110 through the test network 106, including the information required to calculate the performance result. In step 904, performance analyzer 1008 correlates the required performance data with the acquired results from the tests. In step 905, performance analyzer 1008 calculates the result for each metric based on the collected data. And in step 226 from FIG. 2, performance analyzer 1008 stores the solution performance or updates a record associated with the solution with newer solution performance results.

FIG. 10 provides a system deployment architecture for a blockchain-based solution evaluation system according to an exemplary embodiment of the present invention. Blocktest gateway server 1020, an exemplary embodiment of blocktest gateway server 102, comprises test instance configurator 1002, peer network manager 1004, evaluation controller 1006, and performance analyzer 1008, which function as described in FIGS. 1-9. Test network 1060, an exemplary embodiment of test network 106, comprises any number of blockchain test nodes 1100. Each blockchain test node 1100, exemplary embodiments of blockchain test node 110, comprises a node peer manager 1010, a test case generator 1012, a user solution adaptor 1014, and a performance monitor 1018, which may function as described in FIGS. 1-9.

The various implementations above are applicable in a many different and varied operating environments, on one more electronic devices that incorporate integrated circuits, chips for processing and memory purposes. The proper configuration of hardware, software, and/or firmware is presently disclosed above to improve a computer's ability to interface with currency data. A system or method of the present disclosure also includes a number of the above exemplary systems working together to perform the same function disclosed herein.

Most of the exemplary implementations above utilize at least one communications network using one or more commercial protocols, such as TCP/IP, FTP, UPnP, NFS, and CIFS. The networks 306 can be wireless or wired—including a local area network (LAN), a wide-area network (WAN), a virtual private network, the internet, an intranet, an extranet, a public switched telephone network, an infrared network, a wireless network and one or more of the above networks in a combination.

The present disclosure includes at least a database formed from a variety of data stores and other memory or storage media. These components can reside in one or more of the nodes or servers, as discussed above, or may reside in a network of the servers. In certain embodiments, the information may reside in a storage-area network (SAN) Similarly, files for performing the functions attributed to the computers, servers or other network devices may be stored locally and/or remotely, as appropriate. The computing system of the present disclosure, including the client devices, incorporate hardware elements that are electrically coupled via data/control/and power buses. For example, the one or more processors may be central processing units (CPU) for one or more of the client devices. The client devices may further include at least one input device (e.g., a mouse, keyboard, controller, keypad, or touch-sensitive display) and at least one output device (e.g., a display, a printer or a speaker). Such client devices may also include one or more storage devices, including disk drives, optical storage devices and solid-state storage devices such as random access memory (RAM) or read-only memory (ROM), as well as removable media devices, memory cards, flash cards, etc.

The devices in the present disclosure can also include computer-readable storage media reader, communications devices (e.g., modems, network cards (wireless or wired), or infrared communication devices) and memory, as previously described. The computer-readable storage media reader is connectable or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method for testing the performance of a blockchain-based solution, the method
comprising the steps of: receiving the blockchain-based solution;
determining at least one testing requirement of a test network for testing the performance of the blockchain-based solution, wherein the test network comprises a plurality of nodes, and wherein the at least one testing requirement comprises a number of nodes in the test network to be used for the testing and at least one testing role for each node;
transmitting the blockchain-based solution and the at least one testing requirement to the test network;
implementing the at least one testing requirement in said number of nodes in the test network;
testing the blockchain-based solution with said number of nodes in the test network;
determining a performance information relating to the blockchain-based solution; and
receiving from the test network the performance information.

2. The method of claim 1, further comprising the steps of:
storing the performance information on a blockchain.

3. The method of claim 2, wherein the step of storing the performance information comprises cryptographically signing the information.

4. The method of claim 2, wherein the step of storing the performance information comprises encrypting the information.

5. The method of claim 2, wherein the step of storing the performance information comprises cryptographically hashing the information.

6. The method of claim 1, further comprising the step of analyzing the blockchain-based solution to confirm that it can operate in the test network.

7. The method of claim 1, wherein the at least one testing role for each node comprises an evaluation task.

8. The method of claim 1, further comprising the step of calculating a performance metric based on the performance information.

9. A system for testing the performance of a blockchain-based solution comprising:
a test network, comprising a plurality of nodes, configurable to test the blockchain-based solution; and
a server, in communication with said test network,
configured to:
receive the blockchain-based solution;
determine at least one testing requirement of the test network for testing the blockchain-based solution, wherein the at least one testing requirement comprises a number of nodes in the test network to be used for the testing and at least one testing role for each node;
transmit the blockchain-based solution and the at least one testing requirement to the test network; and
receive from the test network performance information relating to the blockchain-based solution.

10. The system of claim 9, further comprising a blockchain storage system in communication with said server, and wherein said server is configured to store the performance information on said blockchain storage system.

11. The system of claim 10, wherein the server is configured to cryptographically sign the performance information.

12. The system of claim 10, wherein the server is configured to encrypt the performance information.

13. The system of claim 10, wherein at least one node is configured to encrypt the performance information.

14. The system of claim 10, wherein the server is configured to cryptographically hash the performance information.

15. The system of claim 9, wherein the server is configured to analyze the blockchain-based solution to confirm that it can operate in the test network.

16. The system of claim 9, wherein the at least one testing role for each node comprises an evaluation task.

17. The system of claim 9, wherein the server is configured to calculate a performance metric based on the performance information.

18. The system of claim 9, wherein at least one node is configured to calculate a performance metric based on the performance information.
